(19) United States
(12) Patent Application Publication
(10) Pub. No.: US 2023/0044185 A1
(43) Pub. Date: Feb. 9, 2023

(54) Mobile Device Handle Accessory

(71) Applicants: Colleen TROY, Watertown, MA (US); David JOHNSON, Watertown, MA (US)

(72) Inventors: Colleen Troy, Watertown, MA (US); David C Johnson, Watertown, MA (US)

(21) Appl. No.: 17/791,487

(22) PCT Filed: Jan. 26, 2021
(86) PCT No.: PCT/US2021/015142

§ 371 Date: Jul. 7, 2022

Related U.S. Application Data
(60) Provisional application No. 62/966,896, filed on Jan. 28, 2020.

(51) Int. Cl. H04B 1/3888; H04M 1/04

(52) U.S. Cl. CPC H04B 1/3888; H04M 1/04

(57) ABSTRACT

A mobile device handle accessory designed to maintain the compact nature of the mobile device, secure a user's hand to the device in order to decrease the likelihood of dropping the mobile device, and minimize the detrimental effects of non-ergonomic hand position during prolonged mobile device use. Herein is described a mobile device handle accessory.

### TECHNICAL FIELD

The subject matter described herein relates to accessories for mobile electronic devices. As used herein, the term “mobile device” may include any type of portable, wireless device such as: a mobile telephone, tablet, mobile point of sale system, portable computer, gaming device, media player, smart phone, personal organizer, and the like. Though the primary embodiment discussed herein relates to an accessory for a mobile telephone, it will be understood that the principles of the invention could be adapted to other geometries for use with other mobile devices.

### CROSS REFERENCE TO RELATED APPLICATIONS

This application claims the benefit of provisional patent application No. 62/966,896 filed 2020 Jan. 28 by the present inventor.

### BACKGROUND

Over recent decades, we have seen a rapid increase in human reliance on mobile devices. Whether calling, messaging, working, searching, selling, purchasing, using social media, viewing media on their device, and more, modern users are regularly operating mobile devices for several hours every single day.

Mobile devices are generally uncomfortable to hold for the extended period of time that modern day users are holding them for, and this extended holding time can be damaging to users' hands and wrists over time. The hand position required to hold these devices is uncomfortable to maintain largely because it can require users to flex their wrist joint upward against the device and to contract the muscles of their hands for long periods of time. For example, when holding a mobile phone, a typical user's hand will be positioned closer to the bottom of the phone than to the top of the phone: placing the device's center of gravity at the top third of the device, making it top-heavy. This can not only make the device more difficult to balance in-hand and therefore easier to drop, but this top-heavy quality bears the top of the device downward and away from the user's wrist, putting pressure on the user's wrist by forcing the palm to extend out and downward.

In order to compensate for the top-heavy quality of their mobile device, a user will often flex their palm upward toward their wrist and against that weight. Prolonged muscle flexion and wrist flexion, extension, and deviation, such as can be experienced with prolonged mobile device use, can reduce circulation to the hand and fingers, put undue stress on the wrist joint, cause muscle stiffness, and increase pressure on the median nerve in the carpal tunnel. This prolonged flexion may aggravate preexisting musculoskeletal disorders (MSDs) in users, such as carpal tunnel, tendinitis, and arthritis, or contribute to the development of these disorders in presently unaffected users.

Furthermore, with increased mobile device use comes an increased risk of users dropping their device and damaging it, regardless of the durability of mobile device case designs.

Most mobile device cases and accessories are not built to reduce the likelihood of a user dropping their phone or device in the first place, nor are they built to address the growing rate of musculoskeletal injuries due to prolonged mobile device use.

Even most mobile device accessories and cases that are being marketed as ergonomic today have significant limitation. Many of these accessories and cases will either: 1) protect the mobile device, but not provide any ergonomic benefit to the user; and/or 2) provide a very limited or token ergonomic feature or experience, such as offering a straight strap or a finger ring that binds the hand to the device case without any quality ergonomic design aspect to it; and/or 3) are ergonomic in their design at the cost of being incredibly bulky (often rounded, block-like, or bulbous in shape), and, thus, are not practical or compact enough for daily use by the average mobile device user.

Users buy a mobile device with the intention of it being mobile: compact and easily stored in a pocket or bag while they are on the go. Creating a device accessory that is shaped spherically may be ergonomic, but it is ultimately useless if the user can no longer easily use and store their device. The accessory will simply not be used regularly and the ergonomic benefit will be wasted.

These realities create a need for a mobile device accessory to provide ergonomic benefit to users, protect the mobile device itself by reducing the likelihood of it being dropped, and keep the compact nature of the mobile device intact. Our ergonomic mobile device handle accessory aims to address these shortcomings in the current market.

### SUMMARY

The subject matter described herein is a mobile device accessory that integrates an ergonomic design with the damage prevention function that an accessory needs to provide for a mobile device: all while maintaining the compact, sleek, and easily stored shape that users need for practical daily use.

### DESCRIPTION OF DRAWINGS

FIG. 1A to 1C represent an embodiment of a mobile device handle accessory in a fully extended position for use, in a fully collapsed position for storage, and a side profile of the fully collapsed position.

FIG. 2A to 2C represent a handle accessory in use on a mobile device.

FIG. 3A to 3B represent an embodiment of the 4 first array of magnetic material and the 6 second array of magnetic material. FIG. 3A represents the handle accessory connecting to a mobile device where the 6 second array of magnetic material is embedded in the mobile device. FIG. 3B represents a side profile of the handle accessory and an enlarged perspective view of the 4 first array of magnetic material.

FIG. 4A to 4C represent three embodiments of the connections in the 2 strap; using 7 pin-like connections, 8 seams or lamination, or 10 stretchy fabric material.

FIG. 5A to 5D represent a sequence of the 2 strap collapsing and the 52 magnetic material securing the 12 left segment and the 14 right segment together when the 2 strap is in its fully collapsed position.

FIG. 6A to 6D represent the 3 bolster in its fully extended position and fully collapsed position, from a top perspective view and a bottom perspective view.

FIG. 7A to 7D represents a 19 interference fit anchor with spring embodiment of the 5 continuous friction mechanism: within the handle accessory, isolated from the handle accessory, and an internal view of the 19 embodiment.

FIG. 8A to 8C represents a 24 interference fit anchor with geared single axle embodiment of the 5 continuous frictions mechanism: within the handle accessory and isolated from the handle accessory with an inner view of the 24 interference fit anchor with geared single axle.

FIG. 9A to 9C represent a 31 sliding anchor embodiment of the 5 continuous friction mechanism within the handle accessory and an internal view of the 31 sliding anchor isolated from the handle accessory.

FIG. 10A to 10C represent a 37 fixed gear box embodiment of the 5 continuous friction mechanism: within the handle accessory, an isolated internal view of the 37 fixed gear box, and an internal view of the 37 fixed gear box connected to the 3 bolster.

### DETAILED DESCRIPTION

The details of one or more variations of the subject matter described herein are set forth in the accompanying drawings and the description below. Other features and advantages of the subject matter described herein will be apparent from the description and drawings, and from the claims.

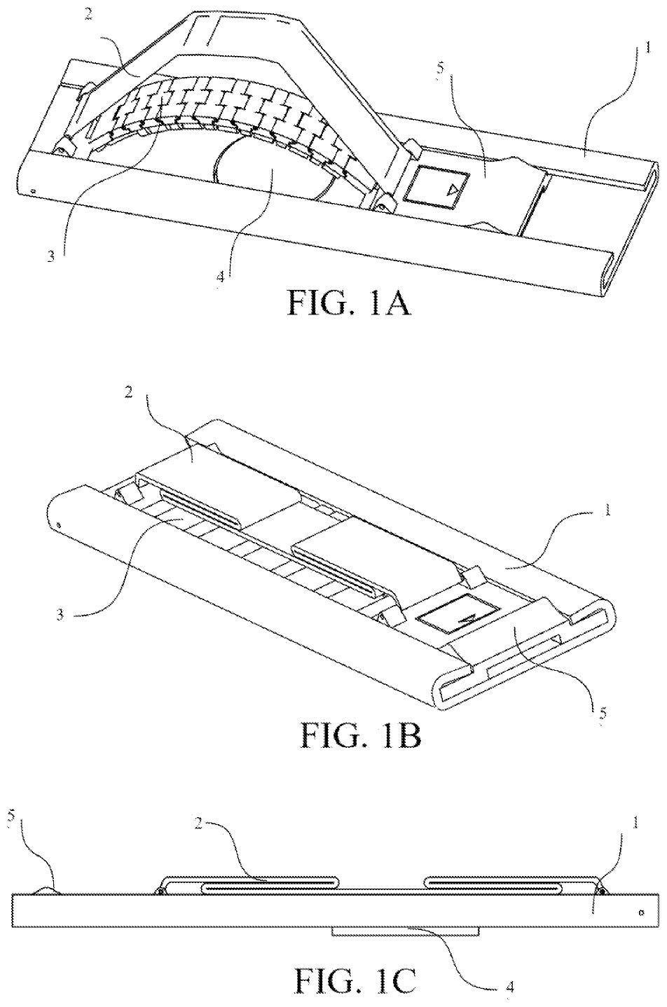

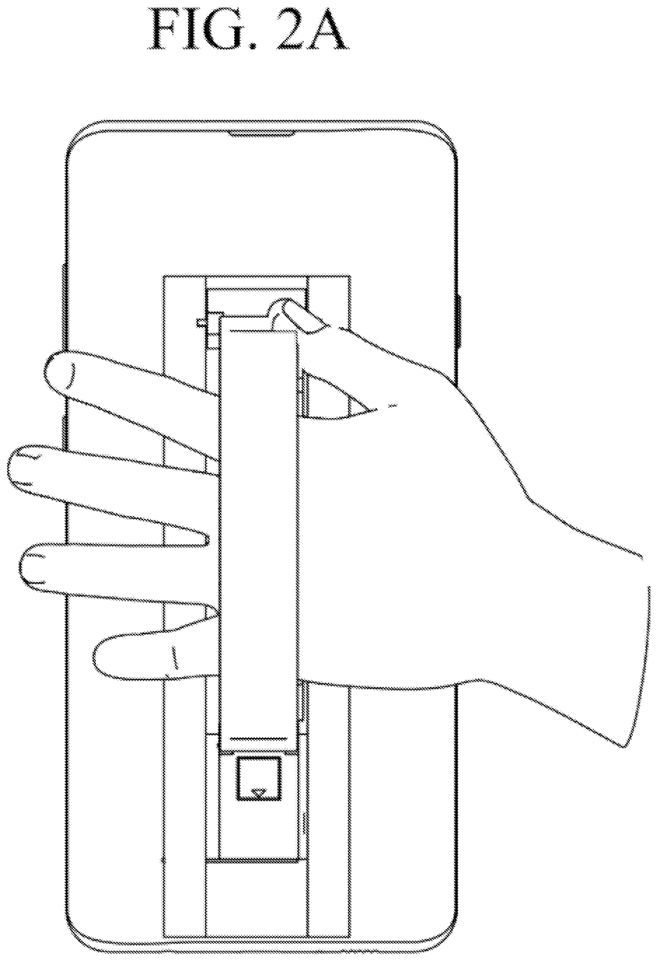

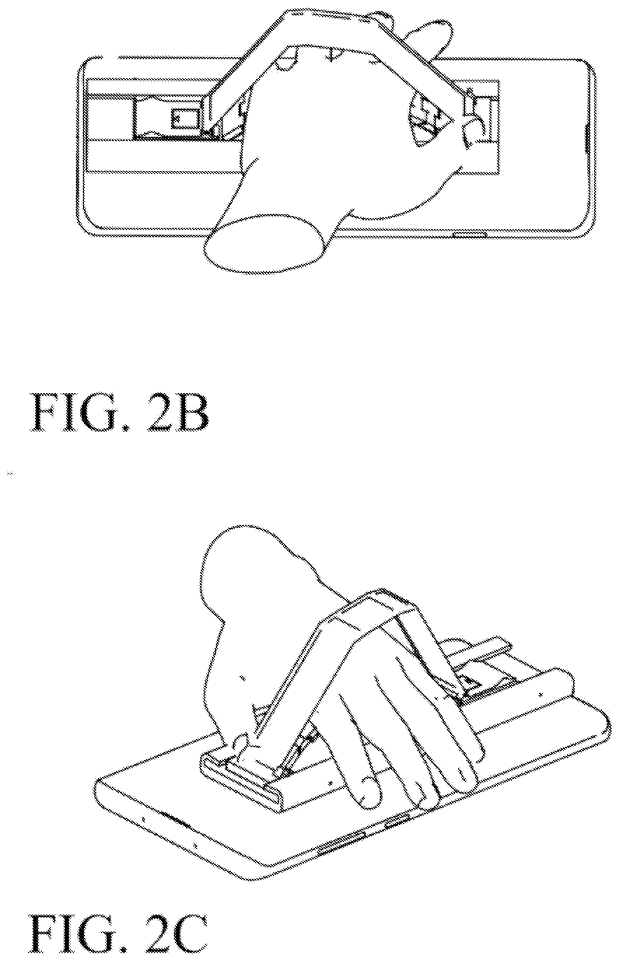

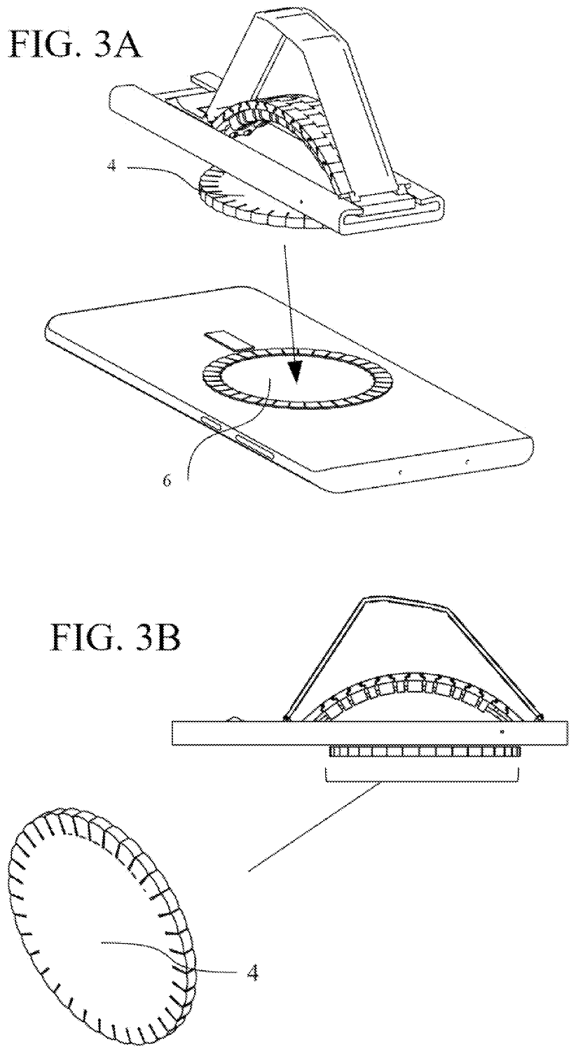

The user will hold a mobile device with the handle accessory, an example of which is illustrated in FIG. 2A to 2C. While the primary function of the handle accessory of FIG. 1A to 1C is similar to a strap, a ring, or a popsocket—to reduce the risk of a user dropping their device—its goals are to provide a much more ergonomic, smooth, and, therefore, luxurious experience than a user can get from a typical mobile device, mobile device case, or mobile device accessory, while maintaining the streamlined and mobile shape that user's need for daily use. The design structure and materials will both be key in maintaining the sleek, lightweight, and easily-stored shape that users need.

When the user slides their hand into the handle accessory, they will slide it underneath the fully collapsed 2 strap and above the ergonomic 3 bolster as illustrated in FIGS. 2A to 2C. The 2 strap and 3 bolster will extend upward with the user's motion. Unfolding or stretching upward to their fully extended positions, the 2 strap will be on top of the user's hand and gently hold the user's hand down onto the phone, and the 3 bolster will be underneath the user's hand and gently push up and support the user's palm. This allows the user's hand to assume a relaxed and more natural hand position than a flat strap, ring, PopSocket, or similar accessory will allow.

When the handle accessory is not in-use, the 2 strap and 3 bolster will collapse down against the 1 rail in order to be as compact as possible.

The handle accessory is made of three base components with an additional component that varies depending on which particular embodiment is being discussed. For ease of understanding, these components will be referred to throughout this document as a, 1 rail: an elongated frame, 2 segmented strap: a first strap-like structure, 3 ergonomic bolster: a second strap-like structure, and 5 continuous friction mechanism. It will be appreciated that these names do not limit the functionality or scope of the components described herein, but they are simply tools for referencing different aspects of the invention for ease of understanding. Included in this document are four possible embodiments of the 5 continuous friction mechanism, referred to as: an 19 interference fit anchor with spring, an 24 interference fit anchor with geared single axle, a 31 sliding anchor, and a 37 fixed gear box.

The 1 elongated frame of the handle accessory referred to as the rail, is the aspect that holds the other components within it. In one embodiment, the 1 rail is an I-beam complement shape. This shaping creates a cavity within the 1 rail that, in some embodiments, can be used to store the 3 bolster and allow the 2 strap to collapse down flat on top of the 1 rail in order for the user to compactly store the handle accessory when it is not in use. In some embodiments, the inside walls of the 1 rail can be toothed for the purpose of actuating a rotary method, such as a gear, or providing friction along a mechanism within the 1 rail.

In some embodiments, within or attached to the underside of the 1 rail can be a 4 first array of magnetic material (such as iron or magnets). This 4 first array can mount the handle accessory to either (1) a 6 second array of magnetic material embedded within a mobile device or mobile device case, thus integrating a magnetic mounting system directly into the mobile device or mobile device case itself, or, (2) any magnetic surface that is large enough and magnetic enough to accommodate the size of the handle accessory and the strength of the magnetic connection within the handle accessory—this is particularly useful for storing the handle accessory when not in use to a common magnetic surface in the house, such as a magnetic refrigerator door or a magnetic door frame.

In embodiments of the 1 rail containing a 4 first array of magnetic material, said 4 first array of magnetic material can be housed within the underside of the 1 rail or within a protrusion from the underside of the 1 rail, referred to as the magnetic housing. A possible embodiment of this magnetic housing is depicted in the related figures as a slightly curved partial-sphere that protrudes downward from the underside of the 1 rail. It will be appreciated that, in other embodiments, said magnetic housing can be alternatively shaped and can be in an alternative location on or within the 1 rail.

In embodiments of the 1 rail containing a 4 first array of magnetic material, said 6 second array of magnetic material can not only be embedded within a mobile device or mobile device case, but it can also be embedded within a thin panel or disc shape that is adhered on top of or on the underside of a mobile device, mobile device case, or other surface. As depicted in the related figures, in some embodiments the rail's said magnetic housing can be slightly curved in order to recess down into the complementary curve of said 6 second array of magnetic material. This will not only consistently guide the user to the correct location at which to connect the Handle accessory to the mobile device, mobile device case, or other magnetic surface, but it can also allow the handle accessory to connect more securely to that mobile device, mobile device case, or magnetic surface than a flat surface would otherwise allow.

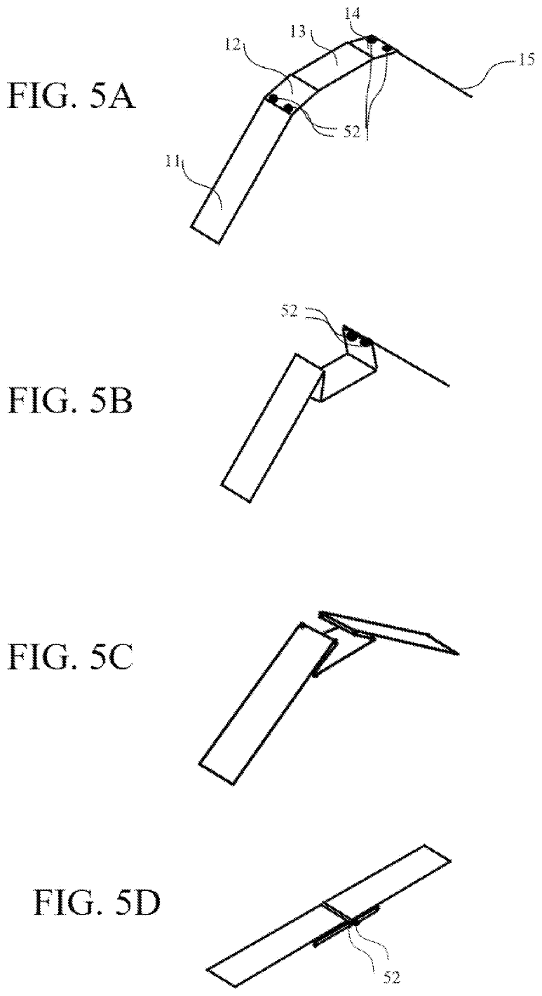

The 2 first strap-like structure, referred to as the strap, is the topmost component of the handle accessory; when in use, the 2 strap can be on top of the user's hand. As illustrated in FIG. 5A to 5D, the 2 strap is comprised of a first plurality of segments so that it is collapsible. It is collapsible for two reasons: 1) to store compactly when not in use and, 2) to allow for two possible hand-positions for users.

While said 2 strap is depicted in the accompanying figures as a straight bar-like shape with five segments, it will be appreciated that the 2 strap may be alternatively shaped and have fewer or more than five segments in other embodiments; some possible reasons can be for manufacturing simplicity or to shape the 2 strap to best fit the curvature of the human hand in order to increase comfort or usability.

Segmentation of 2 strap description:

As illustrated in FIG. 5A to 5D, the 2 strap can be segmented by a 12 left segment, a 14 right segment, a 13 center segment, and two 11,15 end segments. The segments of the 2 strap can be made of a thin, semi-rigid material (such as a flexible plastic or rubber) coated within a soft fabric-like material (such as alcantara) for supreme comfort and durability. Such as in FIG. 5A to 5D, there can be 52 magnetic material in the 12 left segment and in the 14 right segment that will connect when the 2 strap is in its fully collapsed position. The force of the magnetic connection of the 52 magnetic material will securely hold the 2 strap in its fully collapsed position.

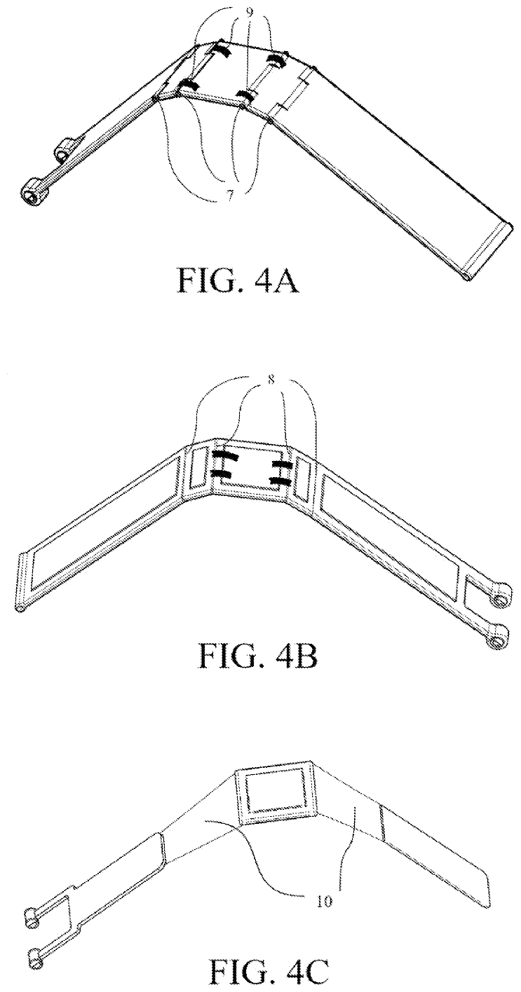

FIGS. 4A to 4C illustrate three possible embodiments of the 2 strap. In one embodiment, the segments can be connected to one another by means of small 7 pin-like mechanisms at the segments' contact points. In a second embodiment, the segments can be connected to one another by means of 8 seams or a laminated section within a foldable fabric-like material at the segments' contact points. In a third embodiment, the segments can be connected to one another by manufacturing said 12 left segment and said 14 right segment from a 10 stretchy or elastic-like fabric.

In all embodiments of the 2 strap, the purpose of the connections between the segments would be so that each segment can fold and unfold easily as the 2 strap extends and collapses.

In all embodiments, as depicted in FIG. 4A to 4B, there can be 9 webbed connections between the 13 center segment and its adjacent 12 left segment and 14 right segment. These 9 webbed connections will hold the 13 center segment beneath the 12 left segment and 14 right segment when the 2 strap is in its fully extended position. This can ensure that the strap's segments collapse down in the order described below (see the ‘mechanism of extending and collapsing the Strap’) necessary for the 2 strap to lie flat on top of the 3 bolster when it is released into its fully collapsed position for storing the 2 strap when not in use.

Description of extending and collapsing the Strap: In one embodiment, when the 2 strap is fully collapsed, the 13 center segment will be on the bottom beneath the 12 left segment and 14 right segment, which will have folded their farthest ends in towards each other and towards the center of 1 rail to lie flat, pulling the strap's two 11,15 end segments in towards the center of the 1 rail to lie flat on top of them as they do so. The said 52 magnetic material located in the 12 left segment and 14 right segment will thus align at the center of the collapsed 2 strap, attracting the opposing 52 magnetic material and holding the 2 strap flat in its fully collapsed position.

In order to extend the 2 strap upward for use, the user will insert their hand underneath the 2 strap and pull upward. The user's pulling force will overpower the force of the 52 magnetic materials' connection to break the magnetic connection, freeing the 12 left segment and 14 right segment to unfold upward and outward, which raises the 13 center segment upward as they do so, stabilizing the 2 strap into its fully extended position.

Because of the segmentation of the 2 strap, the 2 strap allows for two possible user hand positions on a mobile device:

### Position #1: Full-Hand Position

When the 2 strap is fully extended, the user will be able to fit the full length of their fingers underneath the 2 strap; the typical full-hand hold for users around a mobile device would place their bottom-most knuckles approximately underneath or just beyond the 2 strap once their hand is in position.

### Position #2: Finger-Hold Position

When the 2 strap is fully collapsed, the user will be able to fit two or more fingertips underneath the 2 strap to hold their mobile device: the purpose of the finger-hold for users is usually for easy use of their thumb when typing and selecting on their mobile device.

A second strap-like structure, referred to as the 3 bolster, is the component of the handle accessory directly beneath the user's palm. As the user inserts their hand underneath the 2 strap and pulls upward, the 3 bolster will rise up underneath the user's palm to support their hand and guide it into a more ergonomic position than a flat hand position would be. When the 3 bolster is not in use and is fully collapsed, it will lie as flat and as flush as possible within the hollow cavity in the center of the 1 rail.

The 3 bolster will help the wrist and fingers extend in a straighter line from the elbow than a typical mobile phone case can allow (avoiding the user's hand ‘clutching’ around the phone, and reducing wrist flexion, wrist extension, and ulnar/radial deviation). In such embodiments as contain a continuous friction mechanism, the 3 bolster will be positioned in front of the continuous friction mechanism within the 1 rail.

The 3 bolster will have a second plurality of individually articulating segments akin to a human spine or the arch of a stone bridge. While the figures that describe this embodiment show 15 individual segments, it will be appreciated that fewer or more segments may be included in alternative embodiments.

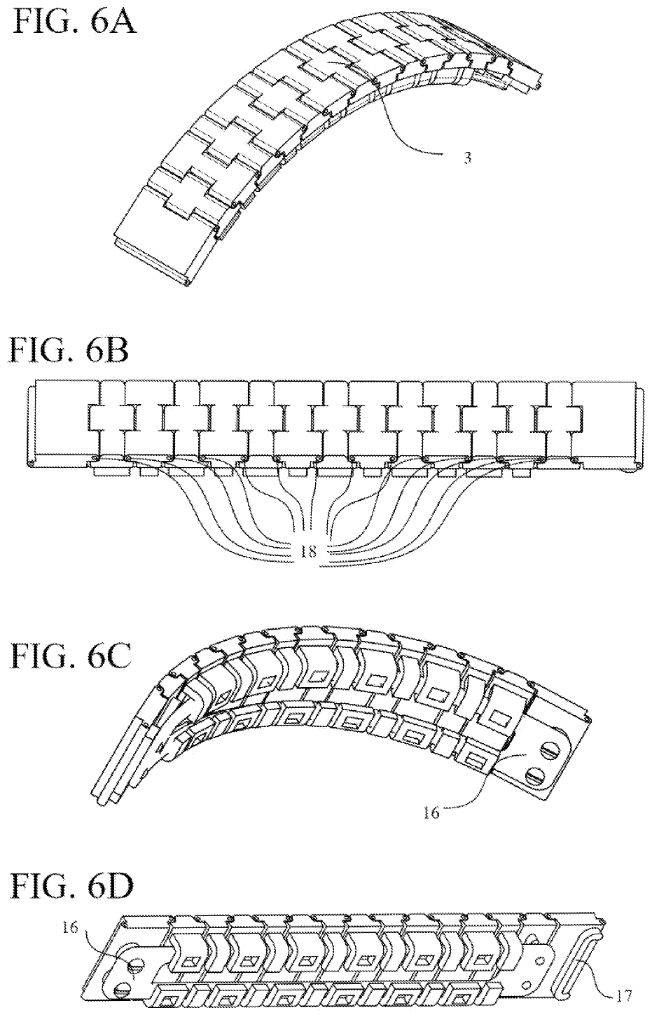

In some embodiments, this second plurality of segments will be supported by a 16 broad strip of semi-rigid material, such as a flexible metal akin to copper, on either or both the underside or the topside of the 3 bolster. FIG. 6A to 6D depict the 16 semi-rigid strip as located underneath the second plurality of segments. This 16 semi-rigid strip can bend with the articulation of the 3 bolster, and the bolster's second plurality of segments can slide along the length of the 16 semi-rigid strip as the 3 bolster extends and collapses. In one embodiment, as depicted in FIG. 6A to 6D, a 17 magnet or plurality of magnets at one end of the 3 bolster can attract the end of the 16 semi-rigid strip to it as this 16 semi-rigid strip moves closer to the end of the 3 bolster upon the articulation of the 3 bolster into its fully extended position. This attraction of the 16 semi-rigid strip to the 17 magnet or plurality of magnets at the end of the 3 bolster can provide a stabilizing magnetic force to securely lock the 3 bolster in its fully extended position, decreasing the likelihood that a user will unintentionally collapse the 3 bolster down by exerting too much force on it during use.

In an additional embodiment, between several of the individual segments can be complementary sets of magnets that will connect when the 3 bolster reaches its fully extended position, thus magnetically connecting several of the individual segments together. This can provide a similar stabilizing magnetic force as the prior embodiment's 17 magnet at the end of the bolster that attracts the 16 semi-rigid strip can provide, encouraging the segments to stay connected in a fully extended position, whereby the 3 bolster is securely locked into a fully extended position.

Another additional embodiment of the 3 bolster, as depicted in 6A to 6D, can use 18 pins, akin to in a watchband, between each segment to connect the individual segments together.

Another possible embodiment of the 3 bolster can use cables, made of a flexible metal or plastic, run through, above, or under the segments to provide support to hold them together.

### General Description of Four Continuous Friction Mechanism Embodiments

A goal of the handle accessory is its ability to provide for the user a smooth and continuous movement of the 2 strap and 3 bolster as they extend upwards during use, rather than locking the 2 strap and 3 bolster into clunky, incremental positions as they extend upward.

Though the 5 continuous friction mechanism is not limited to these embodiments, in these four possible embodiments one end of the 2 strap and one end of the 3 bolster will be fixed within the 1 rail. A 5 continuous friction mechanism within the 1 rail will allow a smooth and contiguous, as opposed to clunky and incremental, movement of the non-fixed 2 strap and 3 bolster ends which smoothly force the centers of the 2 strap and the 3 bolster to arc upwards. This allows the user to pull the 2 strap and the 3 bolster upward in one smooth motion without the limitations and clunky feeling of incremental positions.

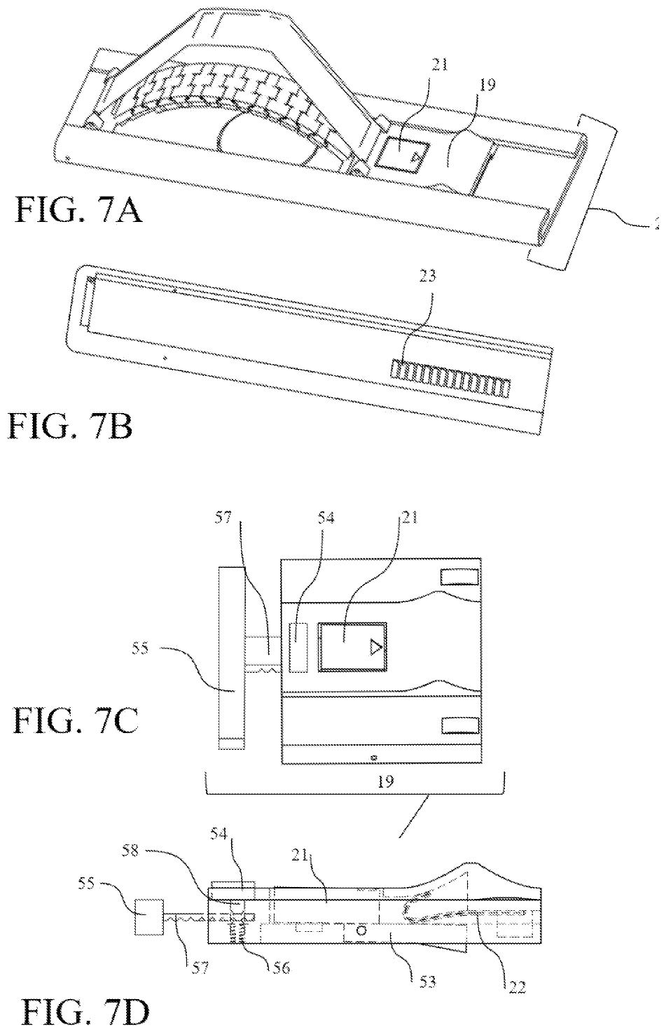

### First Embodiment: Description and Operation of the Interference Fit Anchor with Spring Continuous Friction Mechanism. FIG. 7A-7C

One possible embodiment of the continuous friction mechanism can have a box-like housing referred to as the 19 interference fit anchor with spring. The 19 interference fit anchor with spring will be held within the 1 rail by means of its own shape creating an interference fit with the 1 rail.

In engineering, an interference fit is a fit between two parts in which the external dimension of one part slightly exceeds the internal dimension of the part into which it has to fit. Unlike the 31 sliding anchor embodiment, in this 19 interference fit anchor with spring embodiment the continuous friction will not come from spring clip attachments resisting the movement of the anchor within the 1 rail but, instead, will come from this anchor's 20 interference fit with the walls of the 1 rail. The shape of the 1 rail would be adjusted slightly, with the topmost segments of the 1 rail curved slightly downwards into the 1 rail as they come up and over the 19 interference fit anchor with spring; this curvature will cause the dimensions of the topmost part of the 1 rail to be slightly smaller than the dimensions of the 19 interference fit anchor with spring, thus creating the 20 interference fit between them where the 1 rail will resist the movement of the 19 interference fit anchor with spring along it.

Unlike the 37 fixed gear box embodiment but like the 31 sliding anchor embodiment and 24 interference fit anchor with geared single axle embodiment, this interference fit embodiment of the 5 continuous friction mechanism would not have a completely fixed position and would, instead, be free to move within the length of the 1 rail, along the rail's x-axis.

Similarly to the 31 sliding anchor embodiment and the 24 interference fit anchor with geared single axle embodiment, the non-fixed end of the 2 strap would be attached, most likely by means of a pin, to one end of the 19 interference fit anchor with spring. The non-fixed end of the 3 bolster can be held within the 1 rail, most likely by means of a pin, and be free to move along the rail's x-axis. The non-fixed end of the 3 bolster can be adjacent to the inside end of the 19 interference fit anchor with spring: the end of the interference fit anchor that is closest to the center of the 1 rail.

Action Sequence:

(1) When the user inserts their hand underneath the 2 strap, the 2 strap will begin to extend upwards.
(2) As the non-fixed end of the 2 strap is pulled inwards towards the center of the 1 rail along the rail's x-axis, the 19 interference fit anchor with spring attached to that strap's end is also forced inward towards the center of the 1 rail along with it.
(3) This movement of the 19 interference fit anchor inwards will also push the non-fixed end of the 3 bolster inward towards the center of the 1 rail, forcing the center of the 3 bolster to extend upwards.
(4) As the 19 interference fit anchor with spring moves further into the 1 rail, the walls of the 1 rail will resist the movement of this 19 anchor as it is dragged along the inside walls of the 1 rail, thus providing continuous resistance against this 19 anchor. The user will experience this as the 2 strap and 3 bolster moving smoothly and continuously instead of in clunky incremental positions as they extend upwards.

Rachet system for locking and releasing the 3 bolster's and 2 strap's fully extended positions during use:

One embodiment of a mechanism for locking the 3 bolster and 2 strap into position can be a rachet system in the 1 rail by means of 23 indentations within the inside bottom wall of the 1 rail and a 53 lever within the 19 interference fit anchor with spring. As the 19 interference fit anchor with spring slides across the 23 indentations in the 1 rail as the user inserts their hand underneath the 2 strap during use, the 53 lever will be pulled across and then drop into each consecutive 23 indentation that it slides over. Because one end of the 53 lever is shaped to be complementary to the hollow 23 indentations within the 1 rail, as it drops into each 23 indentation the 53 lever will catch and be unable to move backwards out of the 23 indentation that it has fallen into. This would allow the 19 interference fit anchor with spring to only progress further in towards the center of the 1 rail as the 3 bolster and 2 strap extends upwards, thus the 3 bolster and 2 strap will be prevented from collapsing beyond those points at which the 53 lever catches in 3 bolster's and 2 strap's extensions upward. This would secure the height of the 3 bolster and the 2 strap during use into their fully extended positions: offering added protection against a user unintentionally collapsing the 3 bolster and 2 strap down by exerting too much force upon the handle accessory.

When the user is ready to collapse the 3 bolster and 2 strap after use, they can simply depress the 21 button with their thumb, thereby depressing the straight end of said 53 lever, which is directly below the 21 button. By depressing the straight end of the 53 lever, the user will cause the opposite end of the 53 lever, the end which is complementary to the 23 indentations within the 1 rail, to rotate upwards against the 22 spring clip directly above it and out of the 53 indentations within the 1 rail for so long as the 21 button is depressed for. This will free the 19 interference fit anchor with spring to move along the x-axis of the 1 rail once again. Continuing to depress said 21 button, the user can then pull their thumb, and the 19 interference fit anchor with spring along with it, back away from the center of the 1 rail, collapsing the 3 bolster down into its fully collapsed position.

The 22 spring clip inside the 19 interference fit anchor is positioned above the end of the 53 lever that is complementary to the hollow 23 indentations in the 1 rail. Placed here, the 22 spring clip will resist the downward force of the user depressing the 21 button and cause the 21 button to spring back upward into its original position as soon as the user releases the 21 button.

Setting the distance between the 2 strap and the 3 bolster to accommodate hand width: the 55 bumper system, see FIG. 7C to 7D.

The distance between the 2 strap and the 3 bolster can be adjustable and typically set once by a user to their comfort before they begin using the handle accessory. The distance can be set by means of a 55 bumper system within the 19 interference fit anchor with spring. The 55 bumper will be made from a soft, semi-rigid material, such as a pliable silicone sheathed around a plastic skeleton, so that it does not risk damaging the end of the 3 bolster when it makes contact with it. Below are described two possible embodiments of the 55 bumper system.

A first embodiment (FIG. 7C to 7D) of the 55 bumper system can utilize a 54 button and a 57 linear gear to telescope the 55 bumper further into and out of the 1 rail. The user will depress a second 54 button within the 19 interference fit anchor, depressing the cylindrical 58 rod extension at the end of said 54 button further down into the 19 interference fit anchor with spring. There is an aperture that cuts horizontally through said 58 rod, and within the bottom of the aperture is a small protrusion pointing upwards that is complementary to the teeth of the 57 linear gear attached to the end of the 55 bumper. The 57 linear gear passes through said aperture. When the user depresses said second 54 button, the movement of the 58 rod and its aperture downward will free the teeth of the 57 linear gear to telescope further into and further out of said aperture, and thereby further into and out of the 19 interference fit anchor. This frees the soft 55 bumper at the end of the 57 linear gear to telescope further up or down the 1 rail along the rail's x-axis. The user can then manually pull the 55 bumper to telescope it further into the 1 rail. When the user releases the 54 button, the 55 bumper will be held at that telescoped position in the 1 rail.

A second possible embodiment (figure not shown) of the 55 bumper system can utilize a captive nut and screw to telescope the 55 bumper further into and out of the 1 rail, instead of using a 54 button and a 57 linear gear as described and shown in FIG. 7C to 7D. In this captive nut and screw embodiment, the user can manually rotate a captive nut (instead of depress a 54 button) which would telescope the 55 bumper connected to a captive screw (instead of to a 57 linear gear). The captive nut's direction of rotation will determine the screw's direction of rotation, thereby allowing the user to telescope the 55 bumper further up or further down the 1 rail by virtue of which direction they turn the captive nut. This has an advantage over the 54 button and 57 linear gear embodiment of the 55 bumper system by allowing the user to move the 55 bumper just by turning the captive nut, rather than having to manually grab and pull the 55 bumper.

In both embodiments of the 55 bumper system, the less the user has telescoped the 55 bumper into the center of the 1 rail, the more space will exist between the non-fixed end of the 3 bolster and the 55 bumper. This extra space that the 55 bumper must traverse before making contact with the end of the 3 bolster, will proportionally delay the beginning of the 3 bolster's extension upward after the 19 interference fit anchor begins moving. Therefore, the 3 bolster will not extend as high upwards, and a greater distance will be maintained between the 2 strap and the 3 bolster when they are fully extended. This greater distance will accommodate a thicker hand width.

Conversely, the more the user has telescoped the 55 bumper into the center of the 1 rail, the less space will exist between the non-fixed end of the 3 bolster and the 55 bumper. This smaller space that the 55 bumper will traverse before making contact with the end of the 3 bolster will proportionally hasten the beginning of the 3 bolster's extension upward after the 19 interference fit anchor begins moving. Therefore, the 3 bolster will extend higher upwards, and a smaller distance will be maintained between the 2 strap and the 3 bolster when they are fully extended. This smaller distance will accommodate a smaller, or thinner, hand width.

Near the end of the 54 button's said 58 rod, directly above the 56 spring, a small lip will protrude horizontally from the 58 rod. As the user depresses said second 54 button, the 56 spring will resist the movement of said lip downward. Thereby, the 56 spring will resist the 58 rod's movement downward. When the user releases this second 54 button and frees the 56 spring once more, the 56 spring will push the 54 button back up into its original position.

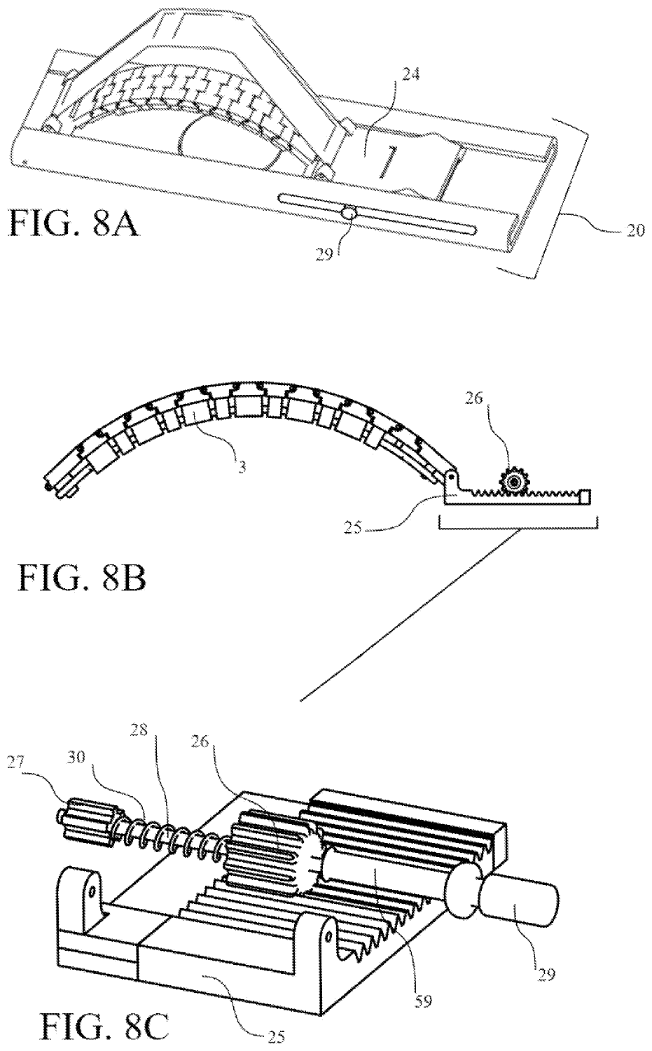

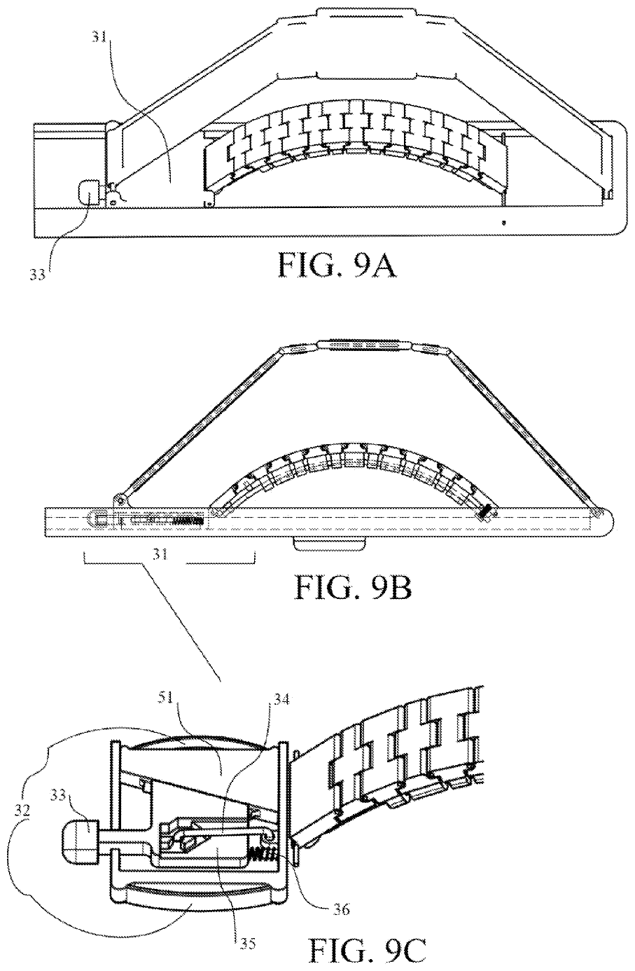

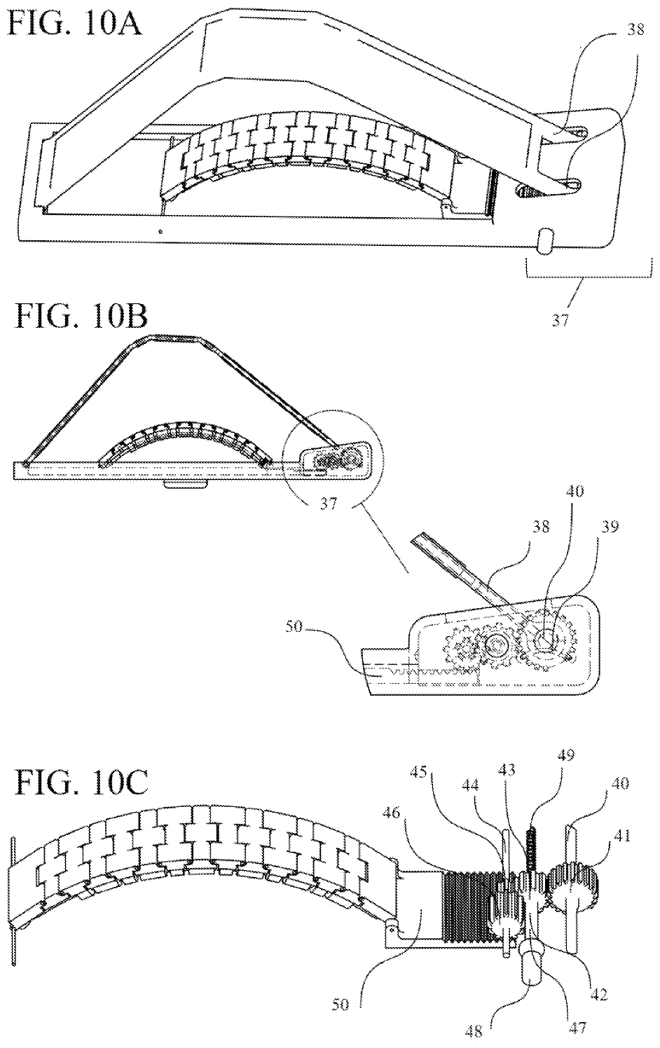

### Second Embodiment: Description and Operation of the Interference Fit Anchor with Geared Single Axle Continuous Friction Mechanism. FIG. 8A-8C

An embodiment of the continuous friction mechanism, also referred to as the 24 interference fit anchor with geared single axle, will combine a modified interference fit anchor (as described in the 19 interference fit anchor with spring) where the 3 bolster has a 25 linear gear attachment and the 1 rail is modified to have a toothed inner wall.

The modification to the interference fit anchor is the addition of a 28 single axle with two gears, a 26 larger gear and a 27 smaller gear, housed within this 24 anchor instead of a 22 spring clip and 21 button.

The modification to the 1 rail is that one or more inside walls of the 1 rail can be toothed in this embodiment so that the 27 smallest gear within this 24 interference fit anchor with geared single axle, near the end of the axle, will be forced to rotate by its contact with the toothed rail wall(s).

This embodiment can allow greater movement of the 3 bolster than the alternative embodiments, and it eliminates the need for the 55 bumper mechanism (see FIGS. 7C and 7D) to set the distance between the 2 strap and bolster, as described in the 19 interference fit anchor with spring embodiment and the 31 sliding anchor embodiment of the 5 continuous friction mechanism.

Action Sequence:

(1) When the user inserts their hand underneath the 2 strap, the 2 strap will begin to extend upwards.
(2) As the non-fixed end of the 2 strap is pulled inwards towards the center of the 1 rail along the rail's x-axis, the 24 interference fit anchor with geared single axle attached to that strap's end is also forced, or pushed, inward towards the center of the 1 rail along with it. Because the 24 interference fit anchor with geared single axle has an 20 interference fit with the 1 rail, the walls of the 1 rail will resist the movement of the 24 interference fit anchor with geared single axle along the length of the 1 rail, thus providing continuous resistance against this 24 anchor.
(3) As the 24 interference fit anchor with geared single axle is dragged in towards the center of the 1 rail, the teeth of the 27 smallest gear are pulled along the teeth of the rail's wall(s), forcing the 27 smallest gear to rotate within the 24 interference fit anchor.
(4) As this 27 smaller gear rotates, it forces the 28 single axle it is upon to rotate with it, forcing the 26 larger gear near the center of the 28 single axle to rotate.
(5) This 26 larger gear will rotate in place on the 25 partially toothed linear gear attached to the nearest end of the 3 bolster. The teeth of this 26 larger gear will catch on the teeth of the 25 partially toothed linear gear as the 26 larger gear rotates, forcing the 25 partially toothed linear gear to move inward towards the center of the 1 rail.
(6) Since the 3 bolster is attached at this end to the 25 partially toothed linear gear, this end of the 3 bolster will be forced inwards towards the center of the 1 rail as well. Since the opposite end of the 3 bolster is fixed to the 1 rail, the center of the 3 bolster is forced to arc upwards as the 25 partially toothed linear gear is pushed inwards into the 1 rail, pushing the 3 bolster up into its fully extended position.

Setting the distance between the 2 strap and 3 bolster to accommodate hand width:

The 28 single axle can be sheathed within a hollow 59 tube for the length of the axle leading up to the 26 larger gear upon it. This 59 tube will allow the user to push the 26 larger gear out of contact with toothed aspect of the 25 partially toothed linear gear, effectively halting the motion of the 3 bolster upward. This would allow the user to pull the 2 strap upward without moving the 3 bolster in order to fit the width of their hand between the 2 strap and the 3 bolster, thus setting their desired distance between the 2 strap and the 3 bolster based on their hand's width. This mechanic is included in order to accommodate the varied widths of individuals' hands. Typically, a user will simply set this distance once to their comfort when they first use the handle accessory.

Action Sequence for setting the distance between the 2 strap and 3 bolster to accommodate hand width:

(1) The user will depress a 29 button at the end of the single axle's 59 tube that will push that hollow 59 tube, and thus the 26 larger gear at its end, down the 28 single axle.
(2) This movement will push the 26 larger gear off of the toothed area of the bolster's 25 partially toothed linear gear, and onto a toothless area of the 25 partially toothed linear gear.
(3) When the 26 larger gear is on this toothless area, the user will be able to insert their hand between the 2 strap and the 3 bolster without rotating the 26 larger gear, and therefore without moving the 3 bolster.
(4) When the user has set their desired distance between the 2 strap and the 3 bolster, the user will release the 29 button, freeing a 30 spring at the opposite end of the 28 single axle from the 29 button to push the 26 larger gear back into its original position on the 28 single axle: onto the toothed area of the 25 partially toothed linear gear.
(5) This 26 larger gear will now be re-engaged with 25 partially toothed linear gear and the 3 bolster will be able to be moved yet again, but this new distance between the 2 strap and the 3 bolster will now be maintained during use.

### Third Embodiment: Description and Operation of the Sliding Anchor Continuous Friction Mechanism. FIGS. 9A-9C

One embodiment of the continuous friction mechanism will have a box-like housing referred to as a 31 sliding anchor. The 31 sliding anchor will be held within the 1 rail via the fitting of one or more 32 spring clip-like attachments between it and the walls of the 1 rail. Unlike the 37 fixed gear box embodiment but like the 19 interference fit anchor with spring embodiment and the 24 interference fit anchor with geared single axle embodiment, this 31 sliding anchor embodiment of the 5 continuous friction mechanism would not have a completely fixed position and would, instead, be free to move within the length of the 1 rail, along the rail's x-axis.

The non-fixed end of the 2 strap would be attached, most likely by means of a pin, to one end of the 31 sliding anchor. The non-fixed end of the 3 bolster can be held within the 1 rail, most likely by means of a pin, and be free to move along the rail's x-axis. Said non-fixed end of the 3 bolster can be adjacent to the inside end of the 31 sliding anchor: the end of the 31 sliding anchor that is closest to the center of the 1 rail.

Action Sequence:

(1) When the user inserts their hand underneath the 2 strap, the 2 strap will begin to unfold and extend upwards.
(2) As the non-fixed end of the 2 strap is pulled inwards towards the center of the 1 rail along the rail's x-axis, the 31 sliding anchor attached to that end of the 2 strap is also forced, or pushed, inward towards the center of the 1 rail along with it. Since the opposite end of the 2 strap is fixed to the 1 rail, the center of the 2 strap is forced to arc upwards, unfolding into its extended position.
(3) The movement of the 31 sliding anchor inwards will also push the non-fixed end of the 3 bolster inward towards the center of the 1 rail. Since the opposite end of the 3 bolster is fixed to the 1 rail, the center of the 3 bolster is forced to arc upwards as the 31 sliding anchor is pushed inwards into the 1 rail, pushing the 3 bolster up into its extended position.
(4) As the 31 sliding anchor moves further into the 1 rail, the 32 spring clips attached to it will resist the movement of the 31 sliding anchor as it is dragged along the inside walls of the 1 rail, thus providing continuous resistance against the 32 spring clips. The user will experience this as the 2 strap and the 3 bolster moving smoothly and continuously instead of in clunky and incremental positions as they extend upwards.

Mechanism for releasing and locking the bolster's fully extended position during use:

This embodiment can contain a 33 button that users can depress in order to securely lock the 3 bolster into its fully extended position during use; this would offer added protection against a user unintentionally collapsing the 3 bolster down during use by exerting too much force on it.

When depressed, the 33 button pushes a perpendicular extension at one end of a 34 rod through a cut-out path within a 35 box-like housing referred to as the lock housing, most likely made of hard plastic or of a similar material. When the end of the 34 rod reaches the end of the first path, it pushes up and over a hook shape at the end of the path and catches there. When the user releases the 33 button, the 34 rod is now held or ‘locked’ at that catch and position in the path.

Locking the 34 rod into this position pushes and holds the 35 lock housing against the nearest end of the 3 bolster within the 1 rail. This movement of the 35 lock housing pushes the 51 floating wedge within the 31 sliding anchor outward and perpendicularly within the 1 rail, thereby wedging the 32 spring clip on the side of that 51 floating wedge up against the inside wall of the 1 rail. This wedge effect stops the movement of the 31 sliding anchor and can effectively lock the 3 bolster into its fully extended position.

The 3 bolster will stay in this locked position until the 33 button is depressed again, freeing the end of the 34 rod by pushing it up and out of the hook-shaped catch at the end of the first path and off onto a second path that allows it to fall back to its initial position with the force of a 36 spring. This 36 spring resists against the 34 rod pushing in towards the center of the 1 rail. The 36 spring is positioned perpendicular to one end of the 35 lock housing, on the opposite side from the 33 button. The release of the 34 rod back into its original position allows the 35 lock housing to drop back to its original position and releases the pressure of the 35 lock housing off of the 51 floating wedge, allowing the 51 floating wedge to fall back in towards the center of the 31 sliding anchor. This frees the 32 spring clip to relax against the inner wall of the 1 rail, thus freeing the 31 sliding anchor and the 3 bolster to move again once more, allowing the 3 bolster to collapse into its fully collapsed position for storage.

Setting the distance between the 2 strap and the 3 bolster to accommodate hand width:

The distance between the 2 strap and the 3 bolster can be adjustable and typically set once by a user to their comfort before they begin using the handle accessory. This distance will be set by means of the same 55 bumper system (see FIGS. 7C and 7D) as described in the 19 interference fit anchor with spring embodiment of the 5 continuous friction mechanism but placed within this embodiment's 31 sliding anchor.

### Fourth Embodiment: Description and Operation of the Fixed Gear Box Continuous Friction Mechanism. FIGS. 10A-10C

Another possible embodiment of the 5 continuous friction mechanism has a 37 box-like housing for gears, referred to as the fixed gear box, located in a fixed position at one end of the 1 rail. At the end of the 2 strap within this 37 fixed gear box, the 2 strap will end in one or a plurality of 38 paddles. For ease of understanding, this document and the accompanying figures will be discussing this embodiment as though it has two 38 paddles.

Action Sequence:

(1) The 38 paddles will be at the end of the 2 strap within the 37 fixed gear box. Below the 38 paddles, attached by both ends to the inside of the 1 rail, will be a 39 spring clip for each 38 paddle. As the user inserts their hand, the 2 strap begins to extend upwards.
(2) As the 2 strap extends upwards, its 38 paddle ends are pulled upon. Since the 38 paddles are affixed to the 40 first axle within the 37 fixed gear box, the 38 paddles cannot move laterally or vertically and are forced to, instead, rotate as the 2 strap moves.
(3) The pressure of the rotation of the 38 paddles against the 39 spring clips below them provides a smooth and continuous friction that the user will experience as the 2 strap and 3 bolster moving smoothly and continuously, instead of in clunky and incremental positions, as they extend upwards.
(4) The rotation of the 38 paddles will also turn the 40 first axle within them. This forces the 41 first gear to rotate.
(5) This motion of the 41 first gear will rotate the 43 second gear that it is in contact with, located on the 42 second axle, and subsequently this 43 second gear will rotate the 45 third gear on the 44 third axle.
(6) The rotation of that 45 third gear will rotate the 44 third axle that it is on, rotating the 46 fourth gear that is also on the 44 third axle.
(7) The 46 fourth gear will rotate in place on the 50 linear gear beneath it, which is attached to the nearest end of the 3 bolster. As the 46 fourth gear rotates, the teeth of the 46 fourth gear will catch on the teeth of the 50 linear gear, forcing the 50 linear gear to move inward towards the center of the 1 rail.
(8) Since the 3 bolster is attached at this end to the 50 linear gear, this end of the 3 bolster will be forced inwards towards the center of the 1 rail as well. Since the opposite end of the 3 bolster is fixed to the 1 rail, the center of the 3 bolster is forced to arc upwards as the 50 linear gear is pushed inwards into the 1 rail, pushing the 3 bolster up into its fully extended position.

Setting the distance between the 2 strap and 3 bolster to accommodate hand width:

Unlike the 40 first axle and 44 third axle, the 42 second axle can be sheathed within a 47 hollow tube for the length of the 42 second axle leading up to the 43 gear upon it. This 47 hollow tube will allow the user to push that 43 second gear out of contact with the 41 first gear and 45 third gear, effectively halting the motion of the 3 bolster upward. This would allow the user to pull the 2 strap upward without moving the 3 bolster in order to fit the width of their hand between the 2 strap and the 3 bolster, thus setting their desired distance between the 2 strap and the 3 bolster based on their hand's width. This mechanic is included in order to accommodate the varied widths of individuals' hands. Typically, a user will simply set this distance once to their comfort when they first use the handle accessory.

Action Sequence for setting the distance between the 2 strap and 3 bolster to accommodate hand width:

(1) The user will depress a 48 button at the end of the 47 tube upon the 42 second axle that will push that 47 hollow tube, and thus the 43 second gear at the end of the 47 tube, down the 42 second axle.
(2) This movement will push the 43 second gear off of the toothed center of the 42 second axle, and onto a toothless area of the 42 second axle.
(3) When the 43 second gear is on this toothless area, the user will be able to insert their hand between the 2 strap and the 3 bolster without rotating the 43 second gear, and therefore without moving the 3 bolster.
(4) When the user has set their desired distance between the 2 strap and the 3 bolster, the user will release the 48 button, freeing a 49 spring at the opposite end of the 42 second axle from the 48 button to push the 43 second gear back into its original position: onto the toothed area of the 42 second axle and between the 41 first gear and 45 third gear. This 43 second gear will now be re-engaged with the 41 first gear and 45 third gear and the 3 bolster will be able to be moved yet again, but this new distance between the 2 strap and the 3 bolster will now be maintained during use.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A mobile device accessory, comprising:
a elongated frame that houses an aspect of each component of said accessory, providing a means of connecting each component with some or all of the other components of said accessory, and
a first strap-like structure comprising a first plurality of segments able to be collapsed, having a means for attachment to said elongated frame, providing a means for holding the user's hand to said accessory, and
a second strap-like structure comprising a second plurality of segments able to be collapsed, having a means for attachment to said elongated frame, providing a means for supporting the underside of the user's hand.

2. The mobile device accessory of claim 1 wherein said elongated frame further includes a first array of magnetic material within it, providing a means of connecting or disconnecting said mobile device accessory to or from a magnetic surface.

3. The mobile device accessory of claim 1 wherein said elongated frame further includes a cavity into which said second strap-like structure can recess into.

4. The mobile device accessory of claim 1 wherein said elongated frame further includes a continuous friction mechanism, having a means for attachment within said elongated frame, providing a means for said first strap-like structure or said second strap-like structure to operate with smooth actuation.

5. The mobile device accessory of claim 4 wherein said continuous friction mechanism further includes a anchor that moves within said elongated frame by means of an interference fit within said elongated frame, where at least one dimension of said elongated frame is smaller than at least one dimension of said anchor, which transfers motion from said first strap-like structure to move said second strap-like structure.

6. The mobile device accessory of claim 4 wherein said continuous friction mechanism further includes a anchor that moves within said elongated frame by means of an interference fit with said elongated frame, which houses a single axle with a plurality of gears upon said single axle wherein a gear selected from the group of said plurality of gears will transmit rotary movement from said first strap-like structure to said single axle, transferring motion from said first strap-like structure to move said second strap-like structure.

7. The mobile device accessory of claim 4 wherein said continuous friction mechanism further includes a anchor that moves within said elongated frame by means of one or more fasteners contacting said anchor to said elongated frame which transfer motion from said first strap-like structure to move said second strap-like structure.

8. The mobile device accessory of claim 4 wherein said continuous friction mechanism further includes a fixed gear box located within said elongated frame which uses a plurality of axles with connected gears upon said axles to transfer motion from said first strap-like structure to move said second strap-like structure.

9. The mobile device accessory of claim 1 wherein said continuous friction mechanism further includes a telescoping bumper mechanism, providing a means for setting the distance between said first strap-like structure and said second strap-like structure during actuation.

10. The mobile device accessory of claim 1 wherein said first strap-like structure further includes a center segment that will collapse downward, pulling a left segment and a right segment adjoining said center segment downward to collapse on top of said center segment.

11. The mobile device accessory of claim 1 wherein said first strap-like structure further includes a fabric-like webbing near enough to the joining of said left segment and said right segment to said center segment to maintain a positioning of said center segment partially beneath said left segment and said right segment, providing a means of forcing said center segment to remain beneath said left segment and said right segment when said first strap-like structure is collapsed.

12. The mobile device accessory of claim 1 wherein said first strap-like structure further includes a plurality of magnets within said left segment and said right segment, providing a means to secure the first strap-like structure down in a collapsed position.

13. The mobile device accessory of claim 1 wherein said second strap-like structure further includes a strip of semi-rigid material on a side of said second plurality of segments, providing a stabilizing interconnection between said second plurality of segments to move along.

14. The mobile device accessory of claim 1 wherein said second strap-like structure further includes magnets between a number of segments selected from the group consisting of said second plurality of segments, providing a stabilizing interconnection between said plurality of segments.

15. The mobile device accessory of claim 1 wherein said second strap-like structure further includes pins at the interconnections between said second plurality of segments.

16. The mobile device accessory of claim 1 wherein said second strap-like structure further includes cables running along said second plurality of segments, providing a stabilizing interconnection between said second plurality of segments.

17. A mobile device accessory, comprising:
a elongated frame that houses an aspect of each component of said accessory and includes a first array of magnetic material within it, providing a means of connecting each component with some or all of the other components of said accessory and a means of connecting or disconnecting said mobile device accessory to or from a magnetic surface, and
a strap-like structure comprising a plurality of segments able to be collapsed, having a means for attachment to said elongated frame, providing a means for holding the user's hand to said accessory.

18. A mobile device accessory, comprising:
a elongated frame that houses an aspect of each component of said accessory and includes a first array of magnetic material within it, providing a means of connecting each component with some or all of the other components of said accessory and a means of connecting or disconnecting said mobile device accessory to or from a magnetic surface, and
a strap-like structure comprising a plurality of segments able to be collapsed, having a means for attachment to said elongated frame, providing a means for supporting the underside of the user's hand.
